(19) United States
(12) Patent Application Publication
(10) Pub. No.: US 2022/0055896 A1
(43) Pub. Date: Feb. 24, 2022

(54) Reduced Corrosion Chlorine Dioxide for Oil & Gas Well Clenaing and Sanitization

(71) Applicants: Gary A. Griesenbeck, Austin, TX (US); Evan M. Heminway, Odessa, TX (US)

(72) Inventors: Gary A. Griesenbeck, Austin, TX (US); Evan M. Heminway, Odessa, TX (US)

(73) Assignee: Orion Water Solutions, LLC, Austin, TX (US)

(21) Appl. No.: 16/998,628

(22) Filed: Aug. 20, 2020

(51) Int. Cl. C01B 11/02; C09K 8/54

(52) U.S. Cl. CPC C01B 11/024; C09K 2208/32; C09K 8/54; C01B 11/028

(57) ABSTRACT

Preparation of an aqueous chlorine dioxide solution that reaches a first chlorine dioxide concentration during a first time period, and reaches a terminal concentration thereafter. A dilute solution of aqueous sodium chlorite or chlorate with predetermined concentration is produced, which yields the terminal chlorine dioxide concentration once an acid activator is added. The dilute solution is transferred through a conduit into a sanitization zone. The acid activator is injected into the conduit at a rate and concentration selected to reach the first chlorine dioxide concentration at the end of the first time period, with a flow rate such that the activated dilute solution of aqueous sodium chlorite has passed through the conduit prior to reaching the first chlorine dioxide concentration, which thereby limits exposure of the conduit to levels less than the first chlorine dioxide concentration.

### BACKGROUND OF THE INVENTION

### Related Applications

None.

### Field of the Invention

The present invention relates to the production and utilization of aqueous chlorine dioxide solutions useful for disinfecting and sanitizing oil and gas petroleum wells, salt water disposal wells, and multiple well water flood operations. More particularly, the present invention relates to the delayed development of chlorine dioxide concentration levels, which results in reduced corrosion of surface piping and equipment, while still providing full concentration levels down-hole in well rework/workover and maintenance operations by “acidizing” the well and geologic formation.

### Description of the Related Art

Chlorine dioxide (ClO₂) is a powerful and selective disinfectant that has been used in various industries since the late 1940's. These include drinking water purification, pulp and paper production, agriculture processes, and petroleum production of oil and gas. Chlorine dioxide is a water-soluble gas that is generated by either oxidizing sodium chlorite (NaClO₂) or reducing sodium chlorate (NaClO3₂). These reactions are prepared in aqueous solutions at a low pH. The chlorine dioxide gas is soluble in water up to a certain concentration depending on temperature and pressure. At high concentrations of chlorine dioxide, the gas can become unstable and potentially explosive. For this reason, safe working concentrations are typically limited to a concentration of 3,000 mg/L (ppm), or less, of the chlorine dioxide gas dissolved into water. Such solutions are stable and safe to use as long as safe handling procedures and appropriate personnel protective equipment are employed. Concentrations up to 7,000 are possible but extreme care must be taken in such application.

In the petroleum industry, a common form of chlorine dioxide production is achieved by mixing an aqueous solution comprising 25% sodium chlorite with 12% sodium hypochlorite (NaOCl or NaClO, bleach) and 15% hydrochloric acid (HCl). This mixture can be injected, or drawn by vacuum, into a water stream that is being treated. Typical mixing ratio for the above concentrations is 1.0 to 0.85 to 0.75 by volume for maximum yield. These solutions can be made continuously in-line or made in batches and pumped into a contaminated water stream. Continuous in-line preparation has traditionally been accomplished using relatively low volume systems employing fluid pressure driven eductors, which require substantial pumping capabilities when scaled to higher volumes.

Because chlorine dioxide generation is typically limited to concentrations of 3,000 ppm (0.3% by weight), or less, in water, the generated gas solution is mostly water. Therefore, it is more cost effective to generate chlorine dioxide at the point of utilization, using whatever source of water might be available. The water can be fresh water, produced water (oilfield brine) from petroleum wells, brackish water, or manmade brine solutions. Once the chlorine dioxide solution is generated, it is then dosed, or injected, into the water stream that requires treatment.

In the petroleum industry, the primary uses of chlorine dioxide are; to kill bacteria which create acid gases that corrode production tubing and pipes; penetrate and destroy biomass colonies that foul wells and hinder petroleum production; to destroy iron sulfide which can plug wells and pipes; to destroy hydrogen sulfide gas which is corrosive, poisonous, flammable, and reduces the value of produced oil (causes sour oil); and, to break down residual hydraulic fracturing polymers that can hinder oil production.

Historically, chlorine dioxide applications in petroleum well operations have included; the treatment of storage impoundments, ponds, and tanks that store water intended for use in a hydraulic fracturing (hereinafter referred to as “frac”) operations; continuous in-line injection during the frac processes, referred to as “frac-on-the fly”; and, treatment of existing producing wells that require work-over maintenance and cleaning due to declining oil production.

Water storage treatment applications generally employ low chlorine dioxide concentration levels. However, in the case of work-over applications on producing petroleum wells, much higher chlorine dioxide concentrations are required to effectively penetrate and destroy biomass, kill bacteria, destroy sulfides, break down residual frac polymers, or in general, clean the well to improve production. These concentrations are often in the 3,000 ppm range, or higher, when pumped down the well. Concentrations up to 7,000 ppm would be desirable from a treatment perspective. However, corrosion of pumping equipment and various safety issues, such as chlorine dioxide off-gassing, must be addressed when handling and pumping such high concentration levels of chlorine dioxide.

Producing chlorine dioxide at concentration levels in the 3,000 to 7,000 ppm range presents a number of challenges. One of the more significant issues is the problem of corrosion, because these concentration ranges can quickly corrode pumping equipment and associated valves and fittings. In the case of workover operations, where treatment water flow rates may range from 1 to 20 barrels per minute, the prior art batch preparation of chlorine dioxide solutions is challenged as to capacity, and storage requirements for such corrosive liquids presents a range of challenges as well, including facilities cost and facilities corrosion and off-gassing of chlorine dioxide which can pose a personnel safety risk. Thus it can be appreciated that there is need in the art for improved methods from the preparation and utilization of chlorine dioxide solutions to address the foregoing prior art challenges.

### SUMMARY OF THE INVENTION

The need in the art is addressed by the methods of the present invention. The present disclosure teaches a method of preparing an aqueous chlorine dioxide solution that reaches a first chlorine dioxide concentration during a first time period, and then reaches a terminal chlorine dioxide concentration thereafter. The method includes preparing a dilute solution of aqueous sodium chlorite that has a predetermined sodium chlorite concentration that is sufficient to achieve a terminal chlorine dioxide concentration once an acid activator is added, and transferring the dilute solution at a flow rate through a conduit and process equipment, and into a sanitization zone. The method also includes injecting the acid activator into the conduit at a rate and concentration that is selected to reach the first chlorine dioxide concentration at the end of the first time period, and selecting the flow rate such that the activated dilute solution of aqueous sodium chlorite has passed through the conduit and process equipment prior to reaching the first chlorine dioxide concentration, which thereby limits exposure of the conduit and process equipment to levels less than the first chlorine dioxide concentration. The method also provides that the terminal chlorine dioxide concentration is achieved within the sanitization zone, which thereby provides sanitization at the terminal chlorine dioxide concentration.

In a specific embodiment, the foregoing method further includes adding a bleach activator to the dilute solution of sodium chlorite, thereby enabling a 3-precursor formulation of chlorine dioxide. In another specific embodiment, the first chlorine dioxide concentration falls within the range of 500 ppm to 750 ppm. In another specific embodiment, the terminal chlorine dioxide concentration falls within the range of 2,000 ppm to 7,000 ppm.

In a specific embodiment of the foregoing method, the preparing a dilute solution of aqueous sodium chlorite step is accomplished using continuous injection of sodium chlorite into a flowing water stream. In another specific embodiment, the preparing a dilute solution of aqueous sodium chlorite step is accomplished using batch mixing of water and sodium chlorite.

In a specific embodiment of the foregoing method, the process equipment is petroleum well surface level pipes, pumps and fittings, and the sanitization zone is down-hole in a petroleum well. In a refinement to this embodiment, the terminal concentration of chlorine dioxide is selected for effective producing petroleum well work-over restoration purposes. In other embodiments, the foregoing method is applied to salt water disposal wells and water floods.

In a specific embodiment of the foregoing method, the acid activator is selected from hydrochloric acid and sulfuric acid. In another specific embodiment, the aqueous sodium chlorite solution is prepared using produced water from petroleum well operations.

The present disclosure also teaches a method of preparing an aqueous chlorine dioxide solution that reaches a first chlorine dioxide concentration during a first time period, and reaches a terminal chlorine dioxide concentration thereafter. The method includes preparing a dilute solution of aqueous sodium chlorate having a predetermined sodium chlorate concentration sufficient to achieve the terminal chlorine dioxide concentration once activated with an acid activator, and transferring the dilute solution of aqueous sodium chlorate at a flow rate through a conduit and process equipment, and into a sanitization zone. The method also includes injecting an acid activator into the conduit at a rate and concentration selected to achieve the first chlorine dioxide concentration at the end of the first time period, and selecting the flow rate such that the activated dilute solution of aqueous sodium chlorate has passed through the conduit and process equipment prior to reaching the first chlorine dioxide concentration, thereby limiting exposure of the conduit and process equipment to levels less than the first chlorine dioxide concentration. The method also provides that the terminal chlorine dioxide concentration is achieved within the sanitization zone, thereby providing sanitization at the terminal chlorine dioxide concentration.

In a specific embodiment, the foregoing method further includes injecting a reducing agent into the conduit at a rate and concentration selected to achieve the first chlorine dioxide concentration at the end of the first time period, wherein the reducing agent is selected from methanol, hydrogen peroxide, and sulfur dioxide.

In a specific embodiment of the foregoing method, the first chlorine dioxide concentration falls within the range of 500 ppm to 750 ppm. In another specific embodiment, the terminal chlorine dioxide concentration falls within the range of 2,000 ppm to 7,000 ppm.

In a specific embodiment of the foregoing method, the preparing a dilute solution of aqueous sodium chlorate step is accomplished using continuous injection of sodium chlorate into a flowing water stream. In another specific embodiment, the preparing a dilute solution of aqueous sodium chlorate step is accomplished using batch mixing of water and sodium chlorate.

In a specific embodiment of the foregoing method, the process equipment is petroleum well surface level pipes, pumps and fittings, and the sanitization zone is down-hole in a petroleum well. In a refinement to this embodiment, the terminal concentration of chlorine dioxide is selected for effective producing petroleum well work-over restoration purposes.

In a specific embodiment of the foregoing method, the acid activator is selected from hydrochloric acid and sulfuric acid. In another specific embodiment, the aqueous sodium chlorate solution is prepared using produced water from petroleum well operations. or brackish or manmade brine solutions.

### BRIEF DESCRIPTION OF THE DRAWINGS

FIG. 1 is a mild steel corrosion rate graph according to an illustrative embodiment of the present invention.

FIG. 2 is a chlorine dioxide activation graph according to an illustrative embodiment of the present invention.

FIG. 3 is a chlorine dioxide activation graph according to an illustrative embodiment of the present invention.

FIG. 4 is a LoCor Activation Rate data table according to an illustrative embodiment of the present invention.

FIG. 5 is a mild steel corrosion rate table according to an illustrative embodiment of the present invention.

FIG. 6 is a chlorine dioxide activation table according to an illustrative embodiment of the present invention.

FIG. 7 is a chlorine dioxide generation system functional block diagram according to an illustrative embodiment of the present invention.

FIG. 8 is a chlorine dioxide generation system functional block diagram according to an illustrative embodiment of the present invention.

FIG. 9 is a process flow diagram according to an illustrative embodiment of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope hereof, and additional fields, in which the present invention would be of significant utility.

In considering the detailed embodiments of the present invention, it will be observed that the present invention resides primarily in combinations of steps to accomplish various methods or components to form various apparatus and systems. Accordingly, the apparatus and system components, and method steps, have been represented where appropriate by conventional symbols in the drawings, showing only those specific details that are pertinent to understanding the present invention so as not to obscure the disclosure with details that will be readily apparent to those of ordinary skill in the art having the benefit of the disclosures contained herein.

In this disclosure, relational terms such as first and second, top and bottom, upper and lower, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a” does not, without more constraints, preclude the existence of additional identical elements in the process, method, article, or apparatus that comprises the element.

The present disclosure teaches novel changes in the preparation and application of a chlorine dioxide processes for disinfecting oil and gas petroleum wells by making the process less corrosive to pumping equipment, more easily deliverable, and cost effective for use in the high volume and high flow rate well treatments. These are applicable for disinfecting conventional vertical wells and for the long runs found in horizontal wells. The novel processes of the present disclosure are also applicable to other industries, where chlorine dioxide sanitization is useful. In addition, the generation of the chlorine dioxide can be delayed and controlled to achieve full strength at desired target depths within the well structure, and this is a substantial benefit from the perspective of managing corrosive damages, and for utilizing higher concentrations (i.e. above 3,000 ppm).

Chlorine dioxide (ClO₂) is a powerful and selective disinfectant that has been used in various industries since the late 1940's. Chlorine dioxide is a water-soluble gas that is generated by either oxidizing sodium chlorite (NaClO₂) or reducing sodium chlorate (NaClO3₂). These reactions are prepared in aqueous solutions at a low pH. The chlorine dioxide gas , that is generated, is soluble in water up to a certain concentration depending on temperature and pressure.

In the petroleum industry, the most common form of chlorine dioxide production is achieved by mixing an aqueous solution comprising a 25% sodium chlorite solution with a 12% sodium hypochlorite (NaOCl or NaClO, common bleach) solution, and a 15% hydrochloric acid (HCl) solution. The hydrochloric acid acts as an activator to the production of chlorine dioxide. Other acids can be used as an activator, such as sulfuric acid or citric acid. The chlorine dioxide solution may be injected, or drawn by vacuum, into a water stream that is being treated. Typical mixing ratio for the above is 1.0 to 0.85 to 0.75 by volume for maximum chlorine dioxide yield, and with favorable economics of production.

As briefly mention hereinbefore, there are two general approaches to making chlorine dioxide, which include the reduction of the chlorate ion (ClO₃), and the oxidation of the chlorite ion (ClO₂). Both methods are applicable to the teachings of the present invention. The methods of chlorate reduction include several common techniques utilized in industry, including: the Mathieson, or SO₂ reduction process; the Solvay, or methanol process; the Kesting process; the Hooker ‘R2’ process; and, the Purate process, also referred to as the EKA process. It is noteworthy that the majority of chlorine dioxide produced in the world today is made by reduction of sodium chlorate. It is produced with high efficiency in a strong acid solution with a suitable reducing agent such as methanol, hydrogen peroxide, hydrochloric acid, or sulfur dioxide. The overall reaction can be written as chlorate+acid+reducing agent→chlorine dioxide+by-products.

With respect to the oxidation of the chlorite ion, the following methods are in common use: strong acid activation of chlorite (HCl+chlorite), which is described in the detail in an illustrative embodiment, hereinafter; aqueous chlorine activation of chlorite (Cl aq+chlorite); chlorine gas activation of chlorite (Cl gas+chlorite), called the Rio Linda method; and, bleach activation of chlorite (NaOCl+HCl+NaClO₂), also called the “3-precursor method”.

Because chlorine dioxide generation is typically limited to concentrations of 3,000 ppm (0.3% by weight), or less, the generated gas solution is mostly water. Therefore, it is more cost effective to generate chlorine dioxide on site, using whatever source of water might be available, as opposed to trucking large volumes to a utilization site. The water can be fresh water or produced water, referred to as oilfield brine from petroleum well operations, brackish water or manmade brine.

In the petroleum industry, the primary uses of chlorine dioxide are: to kill bacteria which create acid gases that corrode production tubing and pipes; penetrate and destroy biomass colonies that foul wells and hinder petroleum production; to destroy iron sulfide which can plug wells and pipes; to destroy hydrogen sulfide gas which is corrosive, poisonous, flammable, and reduces the value of produced oil (causes sour oil); and, to break down residual frac-polymers that can hinder oil production. These uses are achieved via different methods of application depending on the objective of the chlorine dioxide treatment. Generally, these treatments may be referred to a “acidizing” the well.

Chlorine dioxide dose requirements are determined by the contamination level of the water to be treated. In the case of frac water storage facilities, the typical chlorine dioxide dose will range from a few parts per million (“ppm”) up to 300 ppm. In the case of frac-on-the-fly applications, the dose can range from a few ppm up to 200 ppm. In these two applications, standard chlorine dioxide generators are employed. These generators are sized on the pounds per day (“ppd”) of chlorine dioxide that is to be generated, and typically range in size from a few hundred ppd up to 12,000 ppd.

In the case of work-over applications on producing wells, much higher chlorine dioxide concentrations are required to effectively penetrate and destroy biomass, kill bacteria, destroy sulfides, break down residual frac polymers, or in general, clean the well to improve production. These concentrations are often in the 3,000 ppm range, or higher, when pumped down the well. Concentrations up to 7,000 ppm would be desirable from a treatment perspective, however, corrosion of pumping equipment and various safety issues, such as chlorine dioxide off-gassing, must be addressed when handling and pumping such high levels of chlorine dioxide.

During the process of a well work-over, various chemistries can be pumped down the well including water, acid, chlorine dioxide, biocides, chelants, salt, and etc., depending on the well design, formation geology and issues being treated, as will be appreciated by those skilled in the art. The typical process involves pumping liquids and chemicals down the well and into the formation via a specialized, and expensive, high-pressure work-over pump, capable of pressures up to 10,000 psi and flow rates up to 50 barrels per minute (bpm).

The typical oilfield chlorine dioxide generators can only produce 2 to 8 bpm and operate at low pressure. As such, when pumping chlorine dioxide, the maximum downhole flow rate will either be limited, or the chlorine dioxide solution must be made in batches and stored in tanks that can supply the high-pressure work-over pump with adequate volume as required. This limitation results in several disadvantages to the overall well workover task. First, the chlorine dioxide batch process approach requires that the chlorine dioxide solution be made at full strength prior to pumping downhole by the high-pressure workover pump, which then results in costly corrosion of the workover pump and equipment caused by the high concentration chlorine dioxide. Second, safety concerns and controls are required for storing high concentration chlorine dioxide due to risks associated with off-gassing. Third, the chlorine dioxide batch process limits the speed at which well workovers can be performed. This causes the well workover task to take longer and therefore requires the well to be off-line longer, which increases the cost of the workover due to the loss of production profits. Fourth, the low flow limitation of the chlorine dioxide generators does not allow work-over pumps to use high flow rates to enable “diversion by flow rate” process techniques, as are known to those skilled in the art.

The teachings of the present disclosure address various issues, including corrosion, safety, and flow rate when using high concentrations of chlorine dioxide for the purpose of performing workover, restoration, and cleanup of conventional vertical and unconventional horizontal producing petroleum wells. By employing the teachings of the present disclosure, an automated low-energy sodium chlorite pump that provides a controlled delivery over a range of 1 to 50 bpm at 500 to 7,000 ppm is realized. These teachings will provide chlorine dioxide for both small vertical and large horizontal well workovers, with the ability to match the rate of the high-pressure workover pumps.

The teachings of the present disclosure enables operators to reduce or prevent corrosion of surface pumping equipment and treatment of surface iron components by delaying maximum chlorine dioxide concentration build-up. It will be shown that decreasing the relative amount of acid activator in the process also increases the delay time in formation of the chlorine dioxide. In addition, the teachings herein reduce or prevent corrosion of wellhead, wellbore, downhole production strings, and downhole production equipment by delaying maximum chlorine dioxide concentration. In some cases, the chlorine dioxide reaction can be preferentially timed to treat the targeted formation rather than the wellbore and casing. This approach reduces time on location by providing continuous flow rather than batch flow, and reduces power consumption needed by large eductor driven chlorine dioxide generators. In addition, the teachings of this disclosure can be adjusted to generate either 2-precursor chlorine dioxide production, where corrosion concern is the primary issue, or 3-precursor chlorine dioxide production, where yield efficiency is desired. The processes are also designed to generate multiple streams including a dilute blend of sodium chlorite with other additives or full-strength chlorine dioxide in both 2- and 3-precursor formulations. As a practical matter, the processes taught by the present disclosure reduce human exposure to chlorine dioxide gas at the surface of the wellhead. Of course, those skilled in the art will appreciate that these teachings have applications in various other industries outside of the oil and gas industry, including the pulp and paper industries, among others.

Corrosion of pumping equipment can be caused by various chemistries. However, there is a measured, proportional relationship between chlorine dioxide concentration and corrosion rate of carbon steels. This has been observed by high pressure workover pump operators in the form of more frequent pump repair and rebuilds. It has also been confirmed by laboratory coupon testing. As a result, many oilfield service pumpers will not pump chlorine dioxide solutions due to the corrosion concerns.

The present disclosure addresses corrosion problems by delaying the formation of the chlorine dioxide until after it passes through the pumping equipment. This is accomplished by significant dilution of the primary ingredient in chlorine dioxide, which is typically sodium chlorite, as well as the acid activator, which is typically hydrochloric acid, prior to blending. Note that other chemistries may be employed, including the use of sodium chlorate as the primary ingredient, and the use of other activators, including sulfuric acid or citric acid.

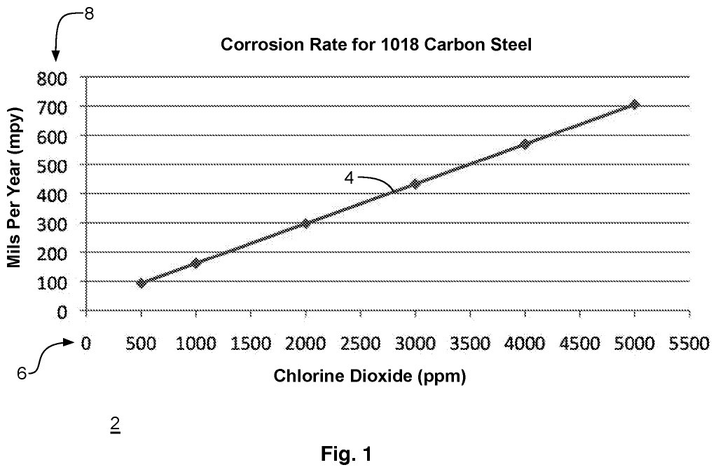

The foregoing process reduces corrosion rates of carbon steel by up to the range of 65% to 87% as compared to the corrosion rates shown in FIG. 1, which will be more fully discussed hereinafter. FIG. 1 also illustrates how the effectiveness of the corrosion reduction improves as the maximum required chlorine dioxide concentration increases.

The present disclosure addresses safety concerns of using high concentration chlorine dioxide with two features of the process. The first safety feature is to control the dilution of the sodium chlorite prior to blending it with the acid activator. The ultimate concentration of the chlorine dioxide solution, in parts per million (“ppm”), is a direct function of the sodium chlorite concentration in the aqueous solution, whether that be fresh water or produced water, brackish water or manmade brine. The concentration can be prepared, controlled, and confirmed, prior to acid activation, by a number of means, which may include titration, refraction, light absorption, oxidation/reduction potential, density, pH and conductivity. In the illustrative embodiment, dilution can be is controlled by software and an algorithm along with redundant process sensors.

The second safety feature exists within the delay process itself. By delaying the reaction of the sodium chlorite and acid, and thereby delaying the development of the chlorine dioxide concentration or strength, the chlorine dioxide concentration at the surface of the workover operation will will always be less than the batch process method or the downhole target concentration, and never higher than the accepted 3,000 ppm safe working limit. Therefore, the potential for safety hazards and the need for controls such as gas scrubbers is minimized or eliminated.

The teachings of the present disclosure significantly increases the maximum flow rate and turn-down ratio of the chlorine dioxide generation process compared to the conventional and available chlorine dioxide generators. This feature makes diversion-by-flow possible by increasing flow rate capacity. Most chlorine dioxide generators work by introducing the sodium chlorite and acid reactants into a slip stream using vacuum eductors. The slip stream solution is then added to the water, or wastewater, being treated. This slip stream process has practical limitations of flow and pressure due to the design and physics of the vacuum eductors, as will be appreciated by those skilled in the art. Multiple eductors can be employed to function over a broader range of flow rates. It should be noted that at the higher flow rates, slip stream pressures and horsepower requirements may be cost prohibitive.

The advancement in the art taught by the present disclosure advantageously utilizes the known corrosion rate of carbon steel when exposed to various chlorine dioxide concentrations to reduce equipment damage caused by such corrosion. Reference is directed to FIG. 1, which is a mild steel (grade 1018 carbon steel) corrosion rate graph 2 according to an illustrative embodiment of the present invention. FIG. 1 indicates the relationship between chlorine dioxide concentration 6 and corrosion 8, as measured by loss of metal mass in mils per year (“mpy”). Note the linear relationship 4 between rate of metal loss and chlorine dioxide concentration. Thusly, a threshold level of acceptable metal loss may be defined for planning and maintenance purposes for equipment exposure. For example, 100 mils per year at 500 parts per million of chlorine dioxide concentration.

The majority of oilfield high-pressure workover pumps and charge pumps are made of carbon steel. Therefore, corrosion rates based on chlorine dioxide concentration can be predicted, and maintenance requirements and expenses can be planned for. Moreover, it has been determined that by delaying the formation of chlorine dioxide concentration, it is possible under the teachings of the present disclosure, to control and minimize the chlorine dioxide concentration that is in contact with the workover pumps, charge pumps, other high-pressure pumps, as well as connected piping and oilfield tubulars. This formation delay technique can substantially reduce pump and piping deterioration, thereby reducing down time and maintenance costs.

The chlorine dioxide formation delay technique can also be utilized to target specific lengths of pipe and well tubular depths at which certain concentrations are formed, which is dependent upon pipe size and aqueous chlorine dioxide flow rates. Concentration levels can be selected and controlled to address specified petroleum bearing formation characteristics as well. Such control allows the higher chlorine dioxide concentration level to target the formation, where higher concentrations are desirable, rather than within the production tubulars or casing.

Under the teachings of the present disclosure, it has been experimentally determined that by first producing a dilute solution of sodium chlorite and water prior to introducing an acid activator, such as hydrochloric acid or sulfuric acid, and omitting the addition of sodium hypochlorite (bleach) altogether, that the formation of full concentration chlorine dioxide is delayed in time in the range of one minute to approximately an hour. While the omission of sodium hypochlorite from the formulation may reduce production cost efficiency somewhat, approximately 15%, that is easily offset by cost savings in equipment corrosion and down time. It has been determined that the ratio of chlorite to water determines the resultant maximum concentration of chlorine dioxide. And further, that a pH of approximately 2.0-4.0 is needed to further the reaction in formation of chlorine dioxide, and this pH level is controlled by the amount of acid activator added, and the lack of bleach in the process. The dilute chlorate/chlorite solution and the ‘last-minute’ addition of the acid activator control and delay the pH level adjustment. Further, that excess acid activator is beneficial to the well because it helps in the foregoing cleaning process, as does the chlorine dioxide.

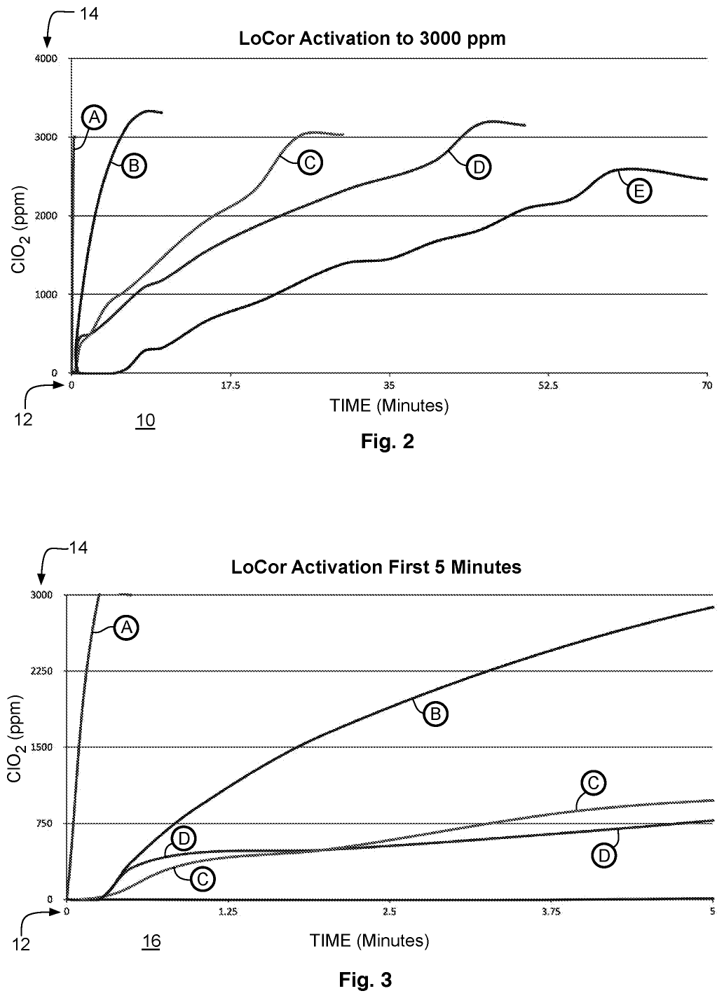

Reference is directed to FIG. 2, which is a chlorine dioxide activation graph 10 according to an illustrative embodiment of the present invention. The graphs plot chlorine dioxide (ClO₂) concentration 14 as a function of time 12 in minutes. FIG. 2 illustrates five curves, where curve ‘A’ illustrates an industry common prior art chlorine dioxide activation rate, and, curves ‘B’, ‘C’, ‘D’, and ‘E’, illustrate four different blends for sodium chlorite production along with an appropriate acid activator according to the teachings of the present disclosure. The industry common formulation was discussed hereinbefore, Each of curves ‘B’, ‘C’, ‘D’, and ‘E’ represent a different rate at which the chlorine dioxide concentrations are achieved. These four curves identify lower corrosion (hereinafter “LoCor”) rate activations as a function of time 12. As discussed hereinbefore, a concentration of 3,000 ppm represents a reasonable safe working full concentration of the chlorine dioxide gas dissolved into water, so that is a threshold level discussed herein. Although higher concentrations may be employed, up to 7,000 ppm, provided that such concentration levels are not achieved until the aqueous solution has been pumped downhole. Lower thresholds will also be discussed with respect to reduced corrosion benefits under the present disclosure. In particular, LoCor rates of 500 ppm and 750 ppm are suggested beneficial levels for reduced corrosion rates at 100 to 150 mils per year metal mass loss, respectively, as will be more fully discussed hereinafter.

In FIG. 2, curve ‘A’ represents a prior art industry-common activation rate, which immediately climbs to 3,000 ppm upon blending the base components of sodium chlorite, sodium hypochlorite, hydrochloric acid and water, as was described hereinbefore. As such, the corrosive effects are quickly reached, such that the pumps and piping at the surface level, and into the well head, are all exposed to corrosive actions at the 3000 ppm concentration. Curves ‘B’, ‘C’, ‘D’, and ‘E’ result from the following 200 milliliter (mL) test batch blending ratios:
‘B’—3.8 mL sodium chlorite in 171.2 mL water, and 25 mL hydrochloric acid.
‘C’—3.8 mL sodium chlorite in 183.7 mL water, and 12.5 mL hydrochloric acid.
‘D’—4.2 mL sodium chlorite in 185.8 mL water, and 10 mL hydrochloric acid.
‘E’—4.0 mL sodium chlorite in 187 mL water, and 9.0 mL hydrochloric acid.

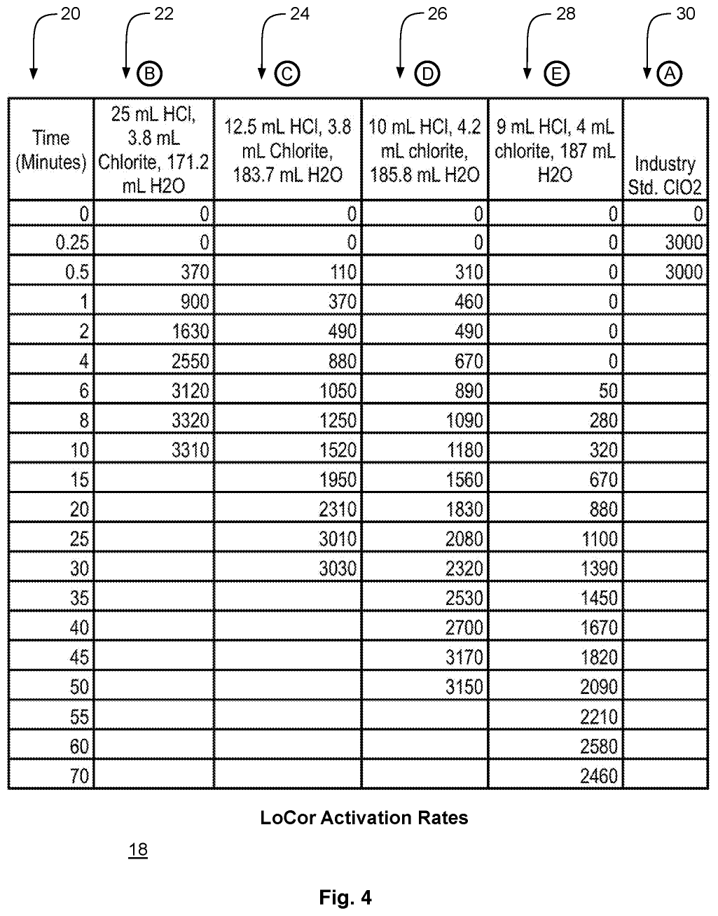

Note that the foregoing blending ratios are based upon commercially available industrial chemical concentrations, including fifteen percent hydrochloric acid aqueous solution (·8 mol/L), and twenty-five percent sodium chlorite aqueous solution. Other component concentrations can certainly be employed, with volumes adjusted to maintain specified, or alternative, ratios. Of course, the volumes are scaled to production levels based on a range of well parameters, as will be appreciated by those skilled in the art. Note that the data set from which these curves were produced is presented in FIG. 4.

In FIG. 2, note that curve ‘A’ reaches 3000 ppm in about 15 seconds, which is effectively an instantaneous reaction. However, curve ‘B’ reaches 3000 ppm in about 5 minutes. Curve ‘C’ takes 30 minutes to reach 3000 ppm, curve ‘D’ takes about 44 minutes to reach 3000 ppm, and curve ‘E’ only reaches about 2500 ppm in 60 minutes. Thus it can be appreciated that the target chlorine dioxide concentration for effective well rework by “acidizing” is delayed, and that the length of the delay can be controlled by adjusting the component ratios. This is affected by diluting the sodium chlorite with water prior to adding the acid activator, and by omitting the use of sodium hypochlorite in the chlorine dioxide production formulation. The time to reach full target concentration can then be utilized in conjunction with pipe sizes and flow rates for any given job, to target the location in the well system where full concentration is achieved, such as in the geologic formation where the benefits of acidizing the well are realized. Generally speaking, the ratio of sodium chlorite (or sodium chlorate) to water determines the concentration of chlorine dioxide generated, the ratio of hydrochloric acid (or acid activator) to water determines the amount of delay, and the reactions occur robustly at a pH of approximately 3.0 and lower.

The blends can be varied to achieve different rates of chlorine dioxide activation to match the desired target concentration, or adjusted for changes in the application or workover pump design. Although delays to reach maximum concentration could be delayed beyond 60 minutes, there is some loss in efficiency of activation beyond 60 minutes, and they are, therefore, not recommended.

Reference is directed to FIG. 3, which is a chlorine dioxide activation graph 16 according to an illustrative embodiment of the present invention. FIG. 3 is actually an enlarged portion of the graph in FIG. 2. In FIG. 3, the time period of most importance is the first few minutes. This graph 16 provides a closer look at the first 5 minutes of activation for the curves ‘A’, ‘B’, ‘C’, and ‘D’, again, plotting chlorine dioxide concentration 14 as a function of time 12.

As a practical matter, a chlorine dioxide concentration of 500 ppm was selected as a readily achievable maximum concentration that the charge pump and workover pump would be exposed to with an acceptable rate of metal loss by corrosion. 750 ppm is another reasonable reference concentration level. As FIG. 3 indicates, the concentration could be even lower under the right circumstances, which would result in an even lower rate of equipment corrosion losses. But 500 ppm provides a conservative baseline from which to plan. As seen in FIG. 3, graph 16, three of the curves ‘B’, ‘C’, and ‘D’ reach 500 ppm between 30 seconds and 120 seconds. The fourth curve, ‘E’ from FIG. 2 is not seen because it lies flat along the time axis 12, and reaches 500 ppm between 12 and 13 minutes (see FIG. 2, and FIG. 4).

Reference is directed to FIG. 4, which is a LoCor Activation Rate data table 18 according to an illustrative embodiment of the present invention. The data in this table 18 was the source information for the graphs 10, 16 in FIGS. 2 and 3, and is referenced to test times in column 20. Note the right-hand column 30 corresponding to plot ‘A’, which is the common industry formulation, where chlorine dioxide concentrations reach 3,000 ppm within fifteen seconds. Respecting the LoCor formulation activation rates, column 22 shows that plot ‘B’ reaches both 500 ppm and 750 in the 30 to 60 seconds window. Column 24 shows that plot ‘C’ reaches 500 ppm at approximately 2 minutes, and 750 ppm at approximately 3 minutes. Column 26 shows that plot ‘D’ reaches 500 ppm at approximately 2 minutes, and 750 ppm at approximately 5 minutes. And, column 28 shows that plot ‘E’ reaches 500 ppm at approximately 12-13 minutes, and 750 ppm at approximately 17-18 minutes. As such, it can be appreciated that varying the formulation controls the rate of activation.

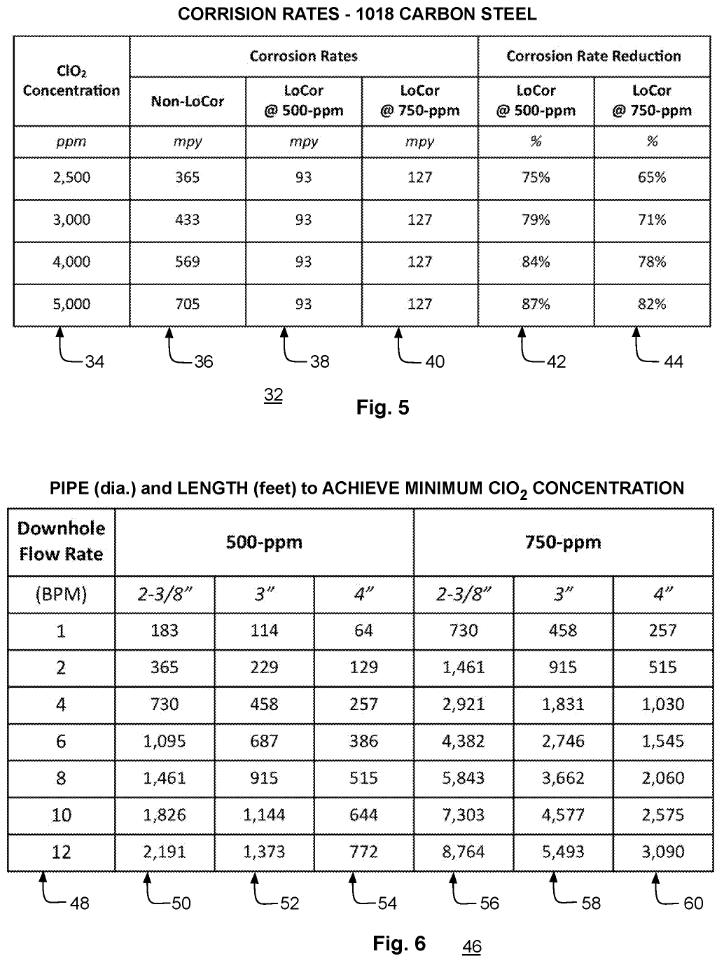

With 500 ppm and 750 ppm established as reasonable baselines chlorine dioxide concentrations in contact with the pumps and hardware, it is reasonable to compare reduced corrosion levels to what the typical corrosion level would be using the aforementioned industry common chlorine dioxide workover processes. Reference is directed to FIG. 5, which is a mild steel corrosion rate table 32 according to an illustrative embodiment of the present invention. This table 32 indicates the relative reduction in corrosion rates (in mils per year “mpy”) for several working concentration listed in column 34, including 2,500 ppm through 5,000 ppm. Although 500 ppm is a conservative maximum value, the table also includes 750 ppm as an alternative conservative, or worst-case, baseline. Note that column 36 shows the rates of corrosion for the industry formulation, so called non-LoCor, ranging from 365 mpy (mils per year) to 705 mpy. Utilizing the 500 ppm formulation LoCor rate in column 38, it can be seen that the corrosion rate is steady to 93 mpy. Thus, the reduction in corrosion rate, shown on column 42 shows a 75% to 87% reduction in equipment corrosion.

Continuing in table 32 of FIG. 5, for the 750 ppm baseline, it can be seen that the corrosion rate is steady to 127 mpy in column 40. Thus, the corresponding reduction in corrosion rate, shown on column 44 ranges from 65% to 82% reduction in equipment corrosion. At either LoCor rate, there is a substantial reduction in the rate of corrosion of the equipment exposed at the 500 ppm or 750 ppm concentration levels, while the well acidizing process still benefits from the much higher concentrations in the range from 2,500 ppm to 5,000 ppm. This is a substantial advancement in the art.

Having established reasonable baseline chlorine dioxide concentrations at 500 ppm and 750 ppm, the time to reach that concentration can be gathered from FIG. 3 depending on which curve is selected. For most applications, 60 seconds is a manageable duration to reach the 500 ppm or 750 ppm concentrations. Of course, other time durations and concentration may be employed. Reference is directed to FIG. 6, which is a chlorine dioxide activation table 46 according to an illustrative embodiment of the present invention. The left column lists acidizing solution flow rates ranging from 1 to 12 barrels per minute (“BPM”), which are reasonable for common well work-over tasks. Columns 50, 52, and 54 list the length of several pipe sizes through which the solution will flow in 60 seconds at the corresponding flow rate at a target concentration of 500 ppm. The pipe sizes are industry common sizes of 2-⅜ inches, 3 inches and 4 inches. At one extreme, with a 1 BPM flow rate through a 4 inch pipe, the solution will flow 64 feet before it reaches 500 ppm chlorine dioxide contraction. All that length of pipe, and other equipment installed along the pipe will benefit from the reduced corrosion features of the present disclosure. At the other extreme, with a 12 BPM flow rate through a 2-⅜ inch pipe, the solution will flow 2,191 feet before the 500 ppm concentration is reaches. This is an example of where the formation of the chlorine dioxide is delayed until the solution is far downhole. The other pipe lengths and flow rates are tabulated from consideration by the reader.

Continuing in FIG. 6, columns 56, 58, and 60 list the length of several pipe sizes through which the solution will flow in 60 seconds at the corresponding flow rate at a target concentration of 750 ppm. The pipe sizes are industry common sizes of 2-⅜ inches, 3 inches and 4 inches. At one extreme, with a 1 BPM flow rate through a 4 inch pipe, the solution will flow 257 feet before it reaches 500 ppm chlorine dioxide concentrations All that length of pipe, and other equipment installed along the pipe will benefit from the reduced corrosion features of the present disclosure. At the other extreme, with a 12 BPM flow rate through a 2-⅜ inch pipe, the solution will flow 8,764 feet before the 750 ppm concentration is reaches. This is an example of where the formation of the chlorine dioxide is delayed until the solution is far downhole and even laterally displaced, such as in a horizontal well. The other pipe lengths and flow rates are tabulated from consideration by the reader.

The pipe distances shown in the table 46 of FIG. 6 illustrate the influence of pipe size and downhole flow rate for specific LoCor curves. There would be a different set of tables for each unique LoCor curve or blend. A programmable logic controller (“PLC”), or other processor, utilizing software and algorithms, can be used to establish these unique tables to achieve the desired target, based on the specific features of the well, pressure lines and pumping apparatus employed.

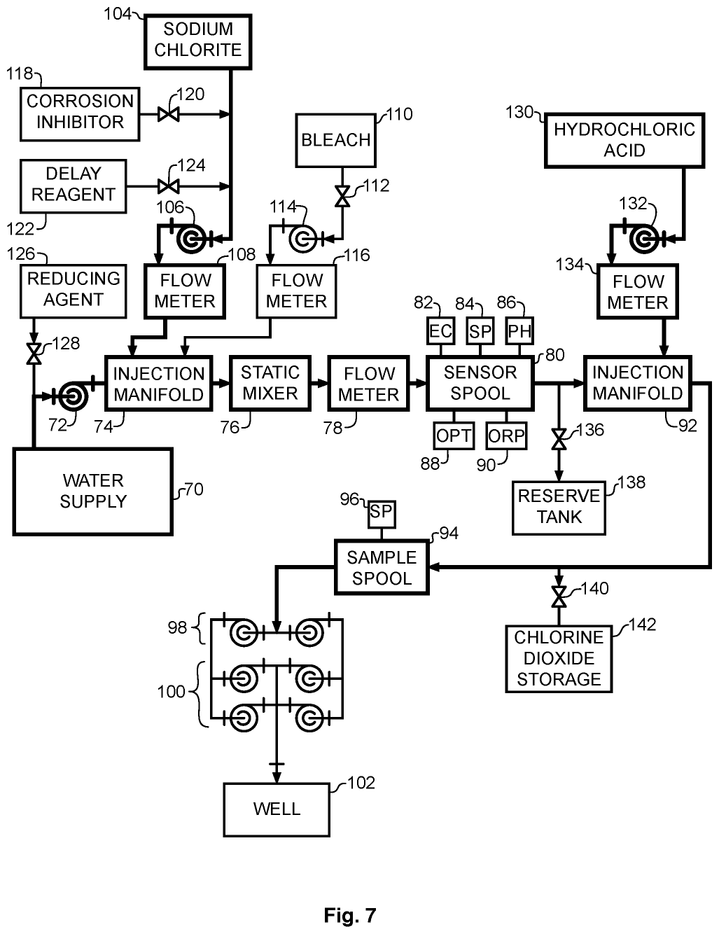

Reference is directed to FIG. 7, which is a chlorine dioxide generation system functional block diagram according to an illustrative embodiment of the present invention. This is one embodiment of a system for producing chlorine dioxide and injecting it into a petroleum well, and includes ancillary features and function desirable in a comprehensive petroleum well rework system. The primary chlorine dioxide producing and injecting functions are represented with bold outlines in the drawing. The primary fluid circuit of liquids begins at a water supply 70 through water pump 72, which discharges into a first injection manifold 74. A storage reservoir 104 of sodium chlorite solution is pumped 106 through a sodium chlorite flow meter 108 and is injected into the water circuit at the first injection manifold 74. The sodium chlorite reservoir 104 contains a 25% aqueous solution of sodium chlorite. With this arrangement, the first injection manifold 74 serves to substantially dilute the sodium chlorite solution according to the flow rates set and monitored by the sodium chlorite flow meter 108 and the flow rate of water pump 72. This is the first step in delaying the formation of the chlorine dioxide, which is to dilute the sodium chlorite to a predetermined level.

The first injection manifold 74 discharges into a static mixer 76, which blends the water and sodium chlorite, and also any other fluid agents that may be added to the flow, which will be further discussed hereinafter. A blended fluid flow meter 78 monitors the blended flow, and discharges into a sensor spool 80, which provides plural ports for sensors. In the illustrative embodiment these sensors include:
EC, 82, an Electrical Conductivity sensor for measuring the amount of dissolved solids (salts) in the blended fluid, which is also is a surrogate indicator of how much chemical is dissolved in the fluid.
SP, 84, a Sample Port for obtaining a liquid sample of the blended fluid.
PH, 86, a pH sensor, which measures acid/base nature of blended fluid, and which is a surrogate measurement that informs the system processor if something is out of specification.
OPT, 88, an OPTEK sensor, which is a manufacturer's name that makes optical sensors that can measure the amount of chlorite, chlorate, and/or chlorine dioxide in the blended fluid, assuming the water is mostly clean.
ORP, 90, an Oxidation Reduction Potential sensor, which has an output coupled to the system processor that corresponds to the amount of oxidizer (chlorite, chlorine dioxide, or bleach) that is in the blended fluid.
Other applications may employ more or less sensors, as will be appreciated by those skilled in the art.

The sensor spool 80 discharges into a second injection manifold 92, which is the point in the process where the acid activator is added into the fluid blend, and which initializes the production of chlorine dioxide. In this illustrative embodiment, hydrochloric acid (15% aqueous solution) is drawn from an acid storage container 130 and pumped by acid pump 132 through a flow meter 134 before it is injected into the fluid blend by the second injection manifold 92. The acid pump 132 provides metered flow under supervision of the acid flowmeter 134, in conjunction with the blended fluid flow meter 78 to achieve the desired blend of component to meet target chlorine dioxide concentrations and times, as discussed hereinbefore. Note that a static mixer in not provided after the second injection manifold because that would accelerate the formation of chlorine dioxide, and alter the planned concentration build-up. If accelerated formation was desired, a static mixer may be employed.

The second injection manifold 92 discharges into a second sample spool 94 adjacent the well 102, where a sample port 96 is provided to access samples of the blended fluid. The blended fluid then enters the charge pump(s) 98 and high pressure pump(s) 100 to be pumped down-hole in the well 102. The delayed production of the target chlorine dioxide concentrations are selected such that no more than the target LoCor concentrations are experienced by the pumps 98, 100, and the acidizing concentration, such as 3,000 ppm, is not achieved until the blended fluids are further down-hole.

Note that there are a number of other features disclosed in the functional block diagram of FIG. 7. These include the possible use of a corrosion inhibitor 118, a delay reagent 122, a reducing agent 126, the addition of bleach 110, and certain reserve and storage options, as follows. Corrosion inhibitors 118, as are known to those skilled in the art, may be metered into the blended fluids by control valve 120, if needed to further reduce corrosive effects upon the system. A delay reagent 122 may be metered into the blended fluid by metering valve 124. Urea, or other chemicals known to those skilled in the art, may be added to buffer the acid activator 130, which in turn aids in the delayed formation of chlorine dioxide when combined with sodium chlorite. A reducing agent may be added to accomplish a system flushing function. Sodium bisulfite and erythorbic acid are two common reducing agents recommended for chlorine dioxide neutralization. For this purpose, the system provides a reducing agent reservoir 126 with a coupling valve 128 that discharges into the water pump 72 suction port.

Even though the use of bleach in this illustrative embodiment is not recommended to achieve the delayed formation of chlorine dioxide, it is an option that may be desired for certain well conditions. In such a case, a bleach reservoir 110 is provided through bleach valve 112 to bleach pump 114, and bleach flow meters 116, to thereby meter the flow of bleach into the blended fluids, which are added at the first injection manifold 74. A bleach option may be useful where an operator requires a three-precursor chlorine dioxide formulation as opposed to a two-precursor formulation. Three-precursor is chemically more cost effective, however, if bleach is employed, the delayed concentration effect will be mitigated.

The illustrative embodiment also provides a reserve tank 138 coupled through valve 136 to store the dilute sodium chlorite solution, prior to the addition of the acid activator, for later use, if desired. Similarly, a chlorine dioxide storage tank 142, coupled through valve 140, is provided to store the blended fluid prior to pumping it down hole. Of course, the chlorine dioxide concentration reaction will continue in the tank 142 until it reaches target concentrations.

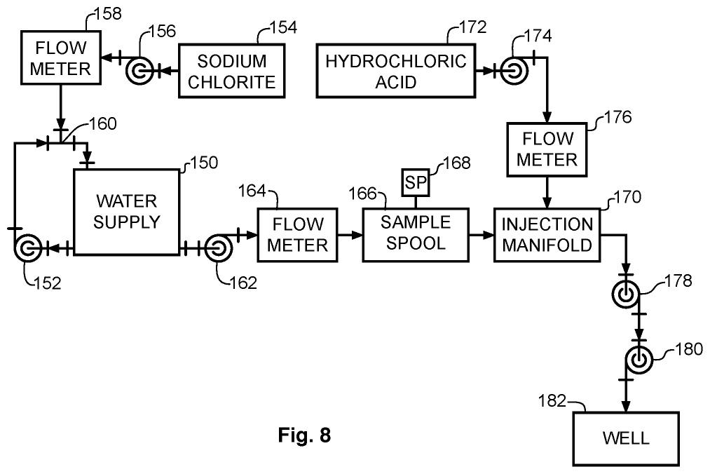

Reference is direct to FIG. 8, which is a chlorine dioxide generation system functional block diagram according to an illustrative embodiment of the present invention. This embodiment teaches a more purpose-built system for producing and utilizing delayed-concentration chlorine dioxide. While other capabilities may be added to enhance system options and performance just the essentials are presented here. In this embodiment, the water supply 150 is a finite volume storage container 150 that is recirculated within itself by water pump 152. As it recirculates, sodium chlorite is added from tank 154 by sodium chlorite pump 156 and sodium chlorite flow meters 158 to blend the water supply 150 into a specific diluted concentration sodium chlorite solution. Note that by the foregoing action, chlorine dioxide is not yet produced at measurable concentrations.

At such time as chlorine dioxide is required for well service operations, blended solution pump 162 is operated, with flow rate monitored by blended solution flow meter 164. The blended fluid is discharged into sample spool 166, where a sample port 168 is provided for obtaining a sample of the blended fluid. Sample spool 166 discharges into injection manifold 170. At the same time, the acid activator, which is hydrochloric acid in acid tank 172 in this embodiment, is pumped by acid pump 176. The acid pump 176 discharges through acid flow meter 176 into injection manifold 170. Thus, within the injection manifold 170, the acid activator begins the concentration build-up of chlorine dioxide according to the delayed reaction discussed hereinbefore. The injection manifold 170 discharges into a charge pump 178 and through high pressure pump 180 into petroleum well 182.

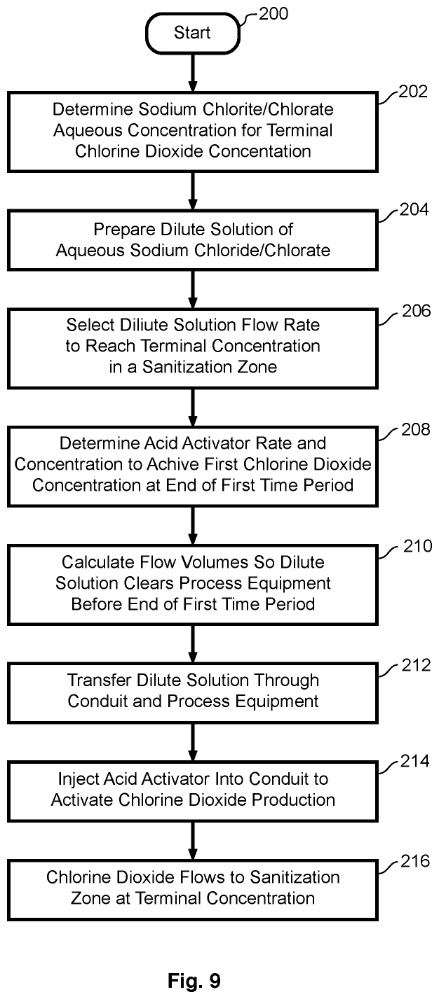

Reference is directed to FIG. 9, which is a process flow diagram according to an illustrative embodiment of the present invention. This flow diagram addresses both the sodium chlorite and sodium chlorate methods. The process begins at step 200 and proceeds to step 202 where an aqueous concentration of either sodium chlorite or sodium chlorate to achieve a desired terminal concentration of chlorine dioxide, such as 3,000 ppm, is determined. At step 204, a dilute solution of either sodium chlorite or sodium chlorate is prepared according to that terminal concentration. At step 206, a flow rate is selected such that matches the high pressure pump rate. At step 208, the concentration and flow rate of an acid activator, such as hydrochloric acid, is selected such that the first chloride dioxide concentration, such as 500 ppm, is reached at the end of a first time period. At step 210, the flow volumes and rates are calculated so that the dilute solution clears the conduit and process equipment before the end of the first time period, thereby preventing the conduit and process equipment from exposure beyond the first chlorine dioxide consternation level. At step 212, the dilute solution is transferred though the conduit and process equipment. At step 214, the acid activator is injected into the conduit, to thereby initialize the formation of chlorine dioxide. At step 2016, the chlorine dioxide, having reached the terminal concentration, reaches the sanitization zone.

Thus, the present invention has been described herein with reference to a particular embodiment for a particular application. Those having ordinary skill in the art and access to the present teachings will recognize additional modifications, applications and embodiments within the scope thereof (does this suffice to include all applications including SWD's , water floods and other markets outside the O&G industry?)

It is therefore intended by the appended claims to cover any and all such applications, modifications and embodiments within the scope of the present invention.

What is claimed is:

1. A method of preparing an aqueous chlorine dioxide solution that reaches a first chlorine dioxide concentration during a first time period, and reaches a terminal chlorine dioxide concentration thereafter, the method comprising the steps of:
preparing a dilute solution of aqueous sodium chlorite having a predetermined sodium chlorite concentration sufficient to achieve the terminal chlorine dioxide concentration once activated with an acid activator;
transferring the dilute solution of aqueous sodium chlorite at a flow rate through a conduit and process equipment, and into a sanitization zone;
injecting the acid activator into the conduit at a rate and concentration selected to achieve the first chlorine dioxide concentration at the end of the first time period;
selecting the flow rate such that the activated dilute solution of aqueous sodium chlorite has passed through the conduit and process equipment prior to reaching the first chlorine dioxide concentration, thereby limiting exposure of the conduit and process equipment to levels less than the first chlorine dioxide concentration, and wherein
the terminal chlorine dioxide concentration is achieved within the sanitization zone, thereby providing sanitization at the terminal chlorine dioxide concentration.

2. The method of claim 1, further comprising the step of:
adding a bleach activator to the dilute solution of sodium chlorite, thereby enabling a 3-precursor formulation of chlorine dioxide.

3. The method of claim 1, and wherein the first chlorine dioxide concentration falls within the range of 500 ppm to 750 ppm.

4. The method of claim 1, and wherein the terminal chlorine dioxide concentration falls within the range of 2,000 ppm to 7,000 ppm.

5. The method of claim 1, and wherein:
the preparing a dilute solution of aqueous sodium chlorite step is accomplished using continuous injection of sodium chlorite into a flowing water stream.

6. The method of claim 1, and wherein:
the preparing a dilute solution of aqueous sodium chlorite step is accomplished using batch mixing of water and sodium chlorite.

7. The method of claim 1, and wherein, the process equipment is petroleum well surface level pipes, pumps and fittings, and the sanitization zone is down-hole in a petroleum well.

8. The method of claim 7, and wherein, the terminal concentration of chlorine dioxide is selected for effective producing petroleum well work-over restoration purposes or salt water disposal well purposes.

9. The method of claim 1, and wherein the acid activator is selected from hydrochloric acid and sulfuric acid.

10. The method of claim 1, and wherein the aqueous sodium chlorite solution is prepared using produced water from petroleum well operations, fresh water, brackish water, or manmade brine.

11. A method of preparing an aqueous chlorine dioxide solution that reaches a first chlorine dioxide concentration during a first time period, and reaches a terminal chlorine dioxide concentration thereafter, the method comprising the steps of:
preparing a dilute solution of aqueous sodium chlorate having a predetermined sodium chlorate concentration sufficient to achieve the terminal chlorine dioxide concentration once activated with an acid activator;
transferring the dilute solution of aqueous sodium chlorate at a flow rate through a conduit and process equipment, and into a sanitization zone;
injecting the acid activator into the conduit at a rate and concentration selected to achieve the first chlorine dioxide concentration at the end of the first time period;
selecting the flow rate such that the activated dilute solution of aqueous sodium chlorate has passed through the conduit and process equipment prior to reaching the first chlorine dioxide concentration, thereby limiting exposure of the conduit and process equipment to levels less than the first chlorine dioxide concentration, and wherein
the terminal chlorine dioxide concentration is achieved within the sanitization zone, thereby providing sanitization at the terminal chlorine dioxide concentration.

12. The method of claim 11, further comprising the step of:
injecting a reducing agent into the conduit at a rate and concentration selected to achieve the first chlorine dioxide concentration at the end of the first time period, wherein the reducing agent is selected from methanol, hydrogen peroxide, and sulfur dioxide.

13. The method of claim 11, and wherein the first chlorine dioxide concentration falls within the range of 500 ppm to 750 ppm.

14. The method of claim 11, and wherein the terminal chlorine dioxide concentration falls within the range of 2,000 ppm to 7,000 ppm.

15. The method of claim 11, and wherein:
the preparing a dilute solution of aqueous sodium chlorate step is accomplished using continuous injection of sodium chlorate into a flowing water stream.

16. The method of claim 11, and wherein:
the preparing a dilute solution of aqueous sodium chlorate step is accomplished using batch mixing of water and sodium chlorate.

17. The method of claim 11, and wherein, the process equipment is petroleum well surface level pipes, pumps and fittings, and the sanitization zone is down-hole in a petroleum well or a salt water disposal well.

18. The method of claim 17, and wherein, the terminal concentration of chlorine dioxide is selected for effective producing petroleum well work-over restoration purposes.

19. The method of claim 11, and wherein the acid activator is selected from hydrochloric acid and sulfuric acid.

20. The method of claim 11, and wherein the aqueous sodium chlorate solution is prepared using produced water from petroleum well operations, fresh water, brackish water, or manmade brine.
